(19) United States
(12) Patent Application Publication
(10) Pub. No.: US 2008/0252882 A1
(43) Pub. Date: Oct. 16, 2008

(54) FILTER ASSEMBLY AND IMAGE ENHANCEMENT SYSTEM FOR A SURVEILLANCE CAMERA AND METHOD OF USING THE SAME

(76) Inventor: JOHN KESTERSON, FAIRFIELD, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/102,358

(22) Filed: Apr. 14, 2008

Related U.S. Application Data
(60) Provisional application No. 60/911,640, filed on Apr. 13, 2007.

(51) Int. Cl. G01J 3/00; G02B 27/28

(52) U.S. Cl. 356/300; 359/485; 359/493; 359/501

(57) ABSTRACT

A filter assembly adapted to be used with a camera for selectively controlling the light that reaches the camera's aperture. In one embodiment, the filter assembly comprises three filters adapted to be independently moved between a first position wherein they are not in front of the camera's aperture and a second position wherein they are in front of the camera's aperture. The first and second filters are polarizing filters adapted to block portions of visible light. The third filter is an infrared filter adapted to block infrared light. In addition to moving between its first position and its second position, the second filter is also adapted to rotate up to 360 degrees. The image captured by the camera may be improved using a computer implemented image enhancement system that uses one or more of multi-spectral imaging, deconvolution, edge enhancement, and dynamic range translation.

### BACKGROUND OF THE INVENTION

This application is based upon U.S. Provisional Application Ser. No. 60/911,640 filed Apr. 13, 2007, the complete disclosure of which is hereby expressly incorporated by this reference.

The present invention relates to a filter assembly and an image enhancement system for use with an optical device such as a camera. More particularly, the invention relates to a filter assembly that selectively prevents some wavelengths and/or orientations of light from passing to a camera's aperture and then uses a computer to enhance the image.

Surveillance cameras are used for a variety of purposes, including taking pictures (including video) of a subject without the subject's knowledge. To prevent the subject from knowing that his/her picture is being taken, it is often necessary for the pictures to be taken while the photographer and subject are in different rooms or in different vehicles or separated by a distance. However, sunlight and/or bright indoor lighting conditions can cause a glare that reduces the ability of the camera to take a sharp identifiable image of the subject. The glare may be caused by light reflecting off of a pane of glass, a mirror, or chrome plating.

Polarizing and infrared (IR) filters are known and used with cameras in the photography industry. Polarizing filters block light polarized at 90 degrees to the filter's polarization axis. If two polarizing filters are placed atop one another at 90 degree angles, no visible light passes through. Most infrared radiation is electromagnetic radiation of a wavelength between about 700 nm and 2300 nm. An infrared filter blocks infrared light.

Traditionally, filters such as polarizing filters and IR filters have been combined with a camera to prevent certain light waves from entering the camera's aperture. However, existing polarizing and IR filters are not adjustable. In other words, a traditional polarizing filter may remove some glare, however, if the directionality of the glared light changes due to the change in position of the sun in the sky, or the angle of the reflecting surface relative to the camera, traditional filters are not easily or automatically adapted to adjust for the changed light conditions. Another problem with existing surveillance cameras is that traditional polarizing filters only comprise one polarizing axis. Therefore, the polarizing filter may not remove the glare if the glared light has a different polarizing axis.

Image enhancement techniques have been used in many fields to improve the quality of images captured from cameras, or to reveal information in the captured image that is not readily visible to the human eye. One such technique is deconvolution, which attempts to characterize the blur in an image that is a consequence of the spherical aberration in the lens associated with the camera, and mathematically remove that blur from the image. This process will sharpen the image and reveal hidden information in the image. This technique has not been used with surveillance cameras because most deconvolution techniques require multiple image planes and take a long time to execute.

Another image enhancement technique that has been used to improve images is to translate information in the darker or brighter portions of an image to the middle gray range of an image. This makes the information in the darker or brighter portions of the image more apparent. This technique is particularly useful when applied to images with a wide dynamic range. These wide dynamic range images are acquired form cameras with a bit depth of ten or more bits per pixel giving them a dynamic range of between 2,000 and 65,000 shades of gray. This technique has not traditionally been applied to surveillance cameras because surveillance cameras are analog video devices with only 8 bits per pixel and 256 shades of gray.

There is therefore a need for a filter assembly and image enhancement system for use with a camera or other optical device that is adapted to sharpen and improve the captured image.

### SUMMARY OF THE INVENTION

The invention comprises a filter assembly and image enhancement system adapted to be used with an optical device such as a camera. The filter assembly is adapted to prevent some wavelengths and/or orientations of light from reaching the camera's aperture. In one embodiment, the filter assembly is adapted to reduce glare caused by a bright light reflecting off of a vehicle's windshield, a pane of glass, a chrome reflector, or the like. The filter assembly can also be used to create an image in which the visible light spectrum is blocked and only infrared light is allowed to reach the camera sensor. The filter assembly can also be used as an adjustable neutral density filter to attenuate the amount of light that reaches the camera aperture.

In one embodiment, the filter assembly comprises three filters adapted to be independently movable between a first position, wherein they are not in front of the camera's aperture, and a second position, wherein they are in front of the camera's aperture. In the second position one or more of the filters prevent certain wavelengths or orientations of light from reaching the camera's aperture.

In one embodiment, the first and second filters are polarizing filters adapted to remove certain orientations of visible light. In addition to moving between its first position and its second position, the second filter is also adapted to rotate up to 360 degrees. The rotation of the second filter helps to optimize the reduction of glare because the angle of the polarized light reflecting from objects in the environment can change if the angle of the light source, i.e. sun, changes. The third filter is an IR filter adapted to block certain wavelengths of infrared light.

The independent movement of the three filters allows multiple filter configurations for different light conditions and user preferences. In one filter configuration, a single polarizing filter (the first filter or the second filter) can be moved to its second position in front of the aperture to remove polarized light and reduce glare reflected from objects in the environment. In another filter configuration, both polarizing filters can be moved to their second position to create an adjustable neutral density filter. This cross polarizing neutral density filter can be used to attenuate very bright light from a scene. To create the neutral density effect, both of the polarizing filters are moved to their second position in front of the camera aperture. The second filter is then rotated. The light passing to the aperture will go from being fully bright to full dark as the second filter rotates through a 90 degree arc relative to the stationary first polarizing filter. This is especially important when using high resolution and very sensitive cameras. Sometimes bright sunlight, especially if it is reflecting from chrome or glass, can be too bright for the camera. Many cameras are equipped with an iris to stop down the light, but when the iris is closed too much it can degrade the quality of the image. By leaving the iris open and inserting the adjustable neutral density filter (by using the two cross polarizing filters) a much better image is produced.

In most configurations, the IR filter remains in its second position thereby removing IR light and allowing only visible light to fall on the camera's sensor. However, in at least one filter configuration, the IR filter is removed and the two polarizing filters are adjusted to be fully cross-polarized thereby blocking all visible light, but allowing some IR light to pass. This configuration is especially useful when photographing scenes that are illuminated by an IR light source. By blocking visible light and allowing only IR light through to the camera's aperture, the user can sharply focus the scene. This is because most lenses are corrected for visible light, but not corrected for IR light.

The image may be improved using a computer implemented image enhancement system that uses one or more of multi-spectral imaging, deconvolution, edge enhancement, and dynamic range translation. The image enhancement system may be used alone or in combination with any of the filter assembly configurations described herein.

### BRIEF DESCRIPTION OF THE DRAWING

FIG. 1 is a perspective view of an embodiment of the invention showing a configuration wherein three filters are in front of the camera's aperture;

FIG. 2 is a perspective view of an embodiment of the invention showing a configuration wherein the two polarizing filters are in front of the camera's aperture but the IR filter is not;

FIG. 3 is a perspective view of an embodiment of the invention showing a configuration wherein only one polarizing filter is in front of the camera's aperture;

FIG. 4 is a flowchart of an embodiment of the invention using a single rotateable polarizing filter;

FIG. 5 is a flowchart of an embodiment of the invention using a rotating polarizing filter and a stationary polarizing filter to create a cross-polarized neutral density filter;

FIG. 6 is a flowchart of an embodiment of the invention using a rotating polarizing filter and a stationary polarizing filter to create a near IR pass filter;

FIG. 7 is a side view of an embodiment of the invention wherein the filter assembly is removably combinable with the camera;

FIG. 8a is a flowchart of an embodiment of the image enhancement system;

FIG. 8b is a continuation of the flowchart of FIG. 8a; and

FIG. 8c is a continuation of the flowchart of FIG. 8b.

### DETAILED DESCRIPTION OF THE INVENTION

The invention comprises a filter assembly and image enhancement system adapted to be used with an optical device such as a camera 12, binoculars, telescope, telephoto lens, or gun scope. Although the invention may be used with any suitable optical device, for simplicity the invention will be described herein as being used with a camera 12. The filter assembly is adapted to prevent certain orientations and/or wavelengths of light from reaching the aperture of the camera 12. In one embodiment, the filter assembly comprises three filters 22, 24, 26 adapted to be independently moved between a first position, wherein they are not in front of the camera's 12 aperture, and a second position, wherein they are in front of the camera's 12 aperture.

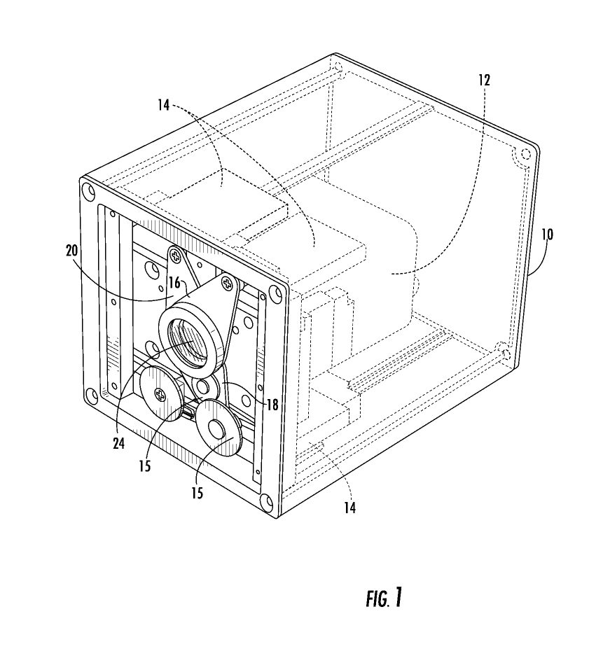

FIGS. 1-3 show an embodiment wherein a camera 12 is mounted in a housing 10. The filters 22, 24, 26 are combined with swing arms 16, 18, 20 which are operatively combined with motors 14. The motors 14 are adapted to move the swing arms 16, 18, 20 between their first and second positions. It should be noted that in alternate embodiments, the filters 22, 24, 26 may be moved between their first and second positions manually or by any other suitable means that does not require a motor 14 or swing arms 16, 18, 20.

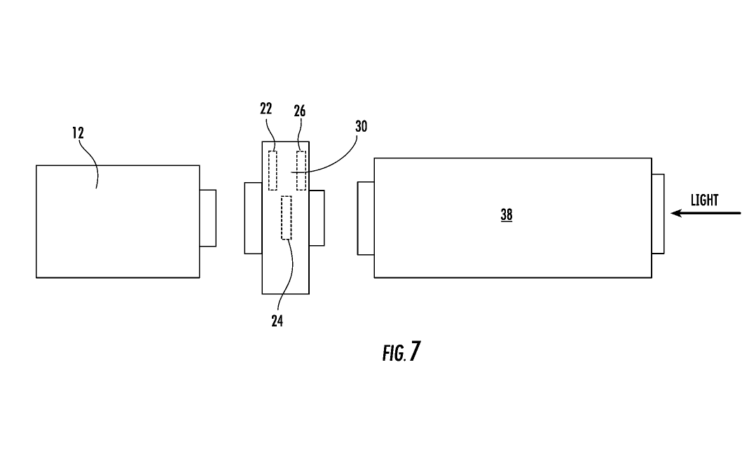

FIG. 7 shows an alternate embodiment wherein the filters 22, 24, 26 are mounted in an adapter 30 capable of being attached to a camera 12. This embodiment allows the filter assembly to be used as an after market add-on suitable for use with most standard cameras 12. As shown in FIG. 7, a first side of the filter assembly adapter 30 may be combined with the camera 12 and a second side of the filter assembly adapter 30 may be combined with a lens 38 such as a telephoto lens. It should be noted that in alternate embodiments the filter assembly of the present invention may be built inside of a camera 12. The general principals of this invention are the same regardless of where the filter assembly is located and whether the filter assembly is capable of being physically separated from the camera 12.

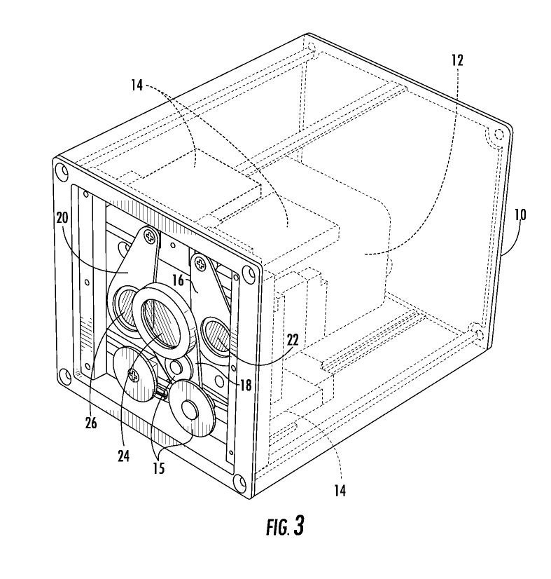

As shown in FIG. 3, one embodiment of the invention comprises three independent filters 22, 24, 26. The first 22 and second 24 filters are polarizing filters adapted to block certain orientations of visible light. In addition to moving between its first position and its second position, the second filter 24 is also adapted to rotate. In one embodiment, the second filter 24 is adapted to rotate up to 360 degrees. In the embodiment shown in FIG. 3, the second filter 24 is mounted in a ring having teeth around its outer edge. The teeth around the ring's edge are adapted to be engaged with gears 15. Gears 15 are operatively combined with a motor 14 so that as the motor 14 causes the gears 15 to rotate, the second filter 24 also rotates. The third filter 26 is an IR filter adapted to block certain wavelengths of infrared light. In one embodiment, the third filter 26 is adapted to block infra-red light at wavelengths above 700 nm.

The independent movement of the three filters 22, 24, 26 allows multiple filter configurations for different light conditions and user preferences. The different filter configurations allow different light waves to fall on the camera's 12 sensor which is important because the different light waves are tuned to the specific functions in the algorithms that process the images. FIG. 3 shows a first filter configuration wherein only one polarizing filter (the first filter 22 or the second filter 24) is in front of the camera's 12 aperture. In the preferred embodiment of this configuration, the second 24 filter is used because its ability to rotate helps to optimize the reduction of glare if the angle of the polarized light reflecting from objects in the environment changes. In this single polarizing filter 24 configuration, filter 24 is moved to its second position in front of the aperture to remove polarized light and reduce glare reflected from objects in the environment such as car windshields or chrome plating. The IR filter 26 may be used with this configuration, however, it is not necessary. It should be noted that this embodiment only requires one filter 24, i.e. the two unused filters 22, 26 do not need to be present for this embodiment to function properly.

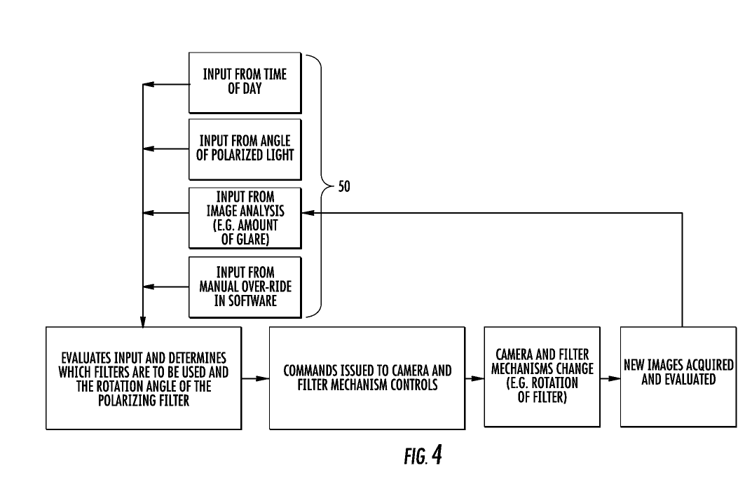

FIG. 4 shows a flow chart for a method of using the first filter configuration shown in FIG. 3 wherein a computer (or any other suitable electronic data manipulating machine) can be used to continuously evaluate the quality of the image and rotate the filter 24 as needed. The loop illustrated in FIG. 4 is iterated until the optimal image is acquired. Optimal is defined as the image with the most glare removed. The loop runs constantly to detect glare in the image and then remove or reduce the glare by rotating the polarizing filter 24. This allows the optimal image to be automatically obtained even as environmental conditions change. As shown in FIG. 4, the computer receives input information 50 including information related to the time of day, the angle of the polarized light, the amount of glare that is in the image, whether the image is moving, and whether the manual over-ride has been selected by the user. The manual over-ride function stops the automated computer process and allows the user to input his/her own settings.

The computer can determine the amount of glare by looking at the variance in the image, which gives an estimate of how sharp the image is. The computer may also gather information about how bright the image is and keep track of changes in sharpness and brightness. The computer evaluates the input information 50 and determines which filters are to be used. As discussed above, the rotatable polarization filter 24 is preferably used in this configuration. After the rotatable polarization filter 24 is moved in front of the aperture, the computer then uses the input information 50 to determine the proper angular position of the filter 24. The filter 24 rotates to its appropriate position to acquire a new image. The process is then repeated using the new image input information 50 to obtain the optimal image. This information can be combined with motion detection so that the system works only when an object is moving (or not moving) across the field of interest.

A second filter configuration is shown in FIG. 1 wherein both polarizing filters 22, 24 are moved to their second position in front of the camera 12 by motors 14 to create an adjustable neutral density filter. This cross polarizing neutral density filter can be used to attenuate very bright light from a scene. To create the neutral density effect, both of the polarizing filters 22, 24 are moved to their second position in front of the aperture of the camera 12. The second filter 24 is then rotated by motor 14. The light passing to the aperture will go from being fully bright to full dark as the second filter 24 rotates through a 90 degree arc relative to the stationary first filter 22. This embodiment is especially useful when a sensitive high resolution camera 12 is being used. Sometimes bright sunlight, especially if it is reflecting from chrome or glass, can be too bright for the camera 12. Cameras 12 are equipped with an iris to stop down the light, but when the iris is closed too much it can degrade the quality of the image. By leaving the iris open and inserting an adjustable neutral density filter (by using the two polarizing filters 22, 24) a much better image is produced. This filter assembly configuration is especially useful with systems that do not have an iris—such as reflecting lenses and telescopes. As shown in FIG. 1, the IR filter 26 is in its second position in front of the aperture of the camera 12, however, the IR filter 26 is not required in this embodiment.

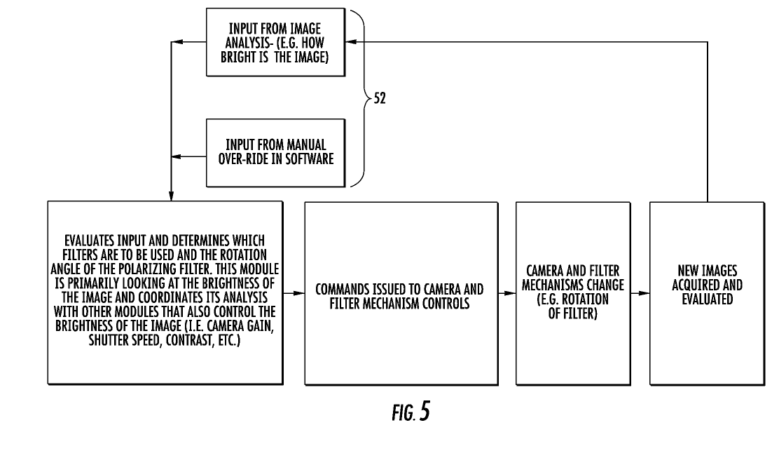

FIG. 5 shows a flow chart for a method of using the second filter configuration shown in FIG. 1 wherein a computer can be used to continuously evaluate the quality of the image and adjust the filter 24 automatically. The loop illustrated in FIG. 5 is iterated until the optimal image is acquired. The optimal image is defined as the image with the best overall brightness and contrast. The loop runs constantly to make small corrections in the angle of the rotation of the polarizing filter to constantly maintain the optimal image as environmental conditions change. As shown in FIG. 5, the system receives input information 50 including information related to the brightness of the image and whether the manual over-ride has been selected by the user. The manual over-ride function stops the automated computer process and allows the user to input his/her own settings. The computer evaluates the input information 50 and determines which filters are to be used. As discussed above, both the stationary polarization filter 22 and the rotatable polarization filter 24 are used in this configuration. After the filters 22, 24 are moved in front of the aperture, the computer then uses the input information 50 to control the brightness of the image. The computer coordinates with other modules of the camera that relate to brightness of the image such as camera gain, shutter speed, and contrast. In controlling brightness, the filter 24 is rotated to dim or brighten the image, as needed. The process is then repeated using the new image input information 50 until the optimal image is obtained.

There are several different methods for determining how much to rotate the filter 24. In one embodiment, the image brightness information is relayed to a computer which determines through calculations whether the image needs to be brightened or dimmed to obtain the optimal image. In another embodiment, instead of doing calculations, the computer compares the image brightness information to pre-set values in a look-up table. The look-up tables comprise information about each lens that is being used so the rotatable filter 24 can be instantly moved to its optimal position based on the input information for the image. The computer continues to monitor the input information and change the position of the filter 24 if new input information is detected. This look-up table embodiment makes the process faster and also more accurate and predictable.

The look-up table can be derived in one of several ways. It can be derived through a series of formulae and calculations based on the optics of the lens, the camera sensor and/or the nature of the light from a scene. It can also be derived through empirical means. An example of such an empirical means would be to expose a given lens/camera sensor combination to varying levels of light, capture an image from each light level, calculate the quality of the image using one or more measures, such as the modulation transfer function, or a measurement of image noise, and determine the best settings to produce the highest quality image. These values for these best settings would comprise the look-up table.

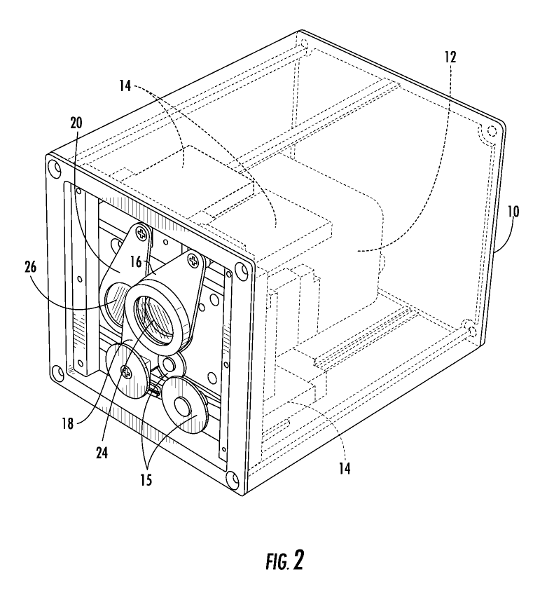

In most configurations, it is beneficial for the IR filter 26 to remain in its second position thereby preventing IR light from falling on the camera's 12 sensor. However, in the third filter configuration show in FIG. 2, the IR filter 26 is removed and the two polarizing filters 22, 24 are adjusted to be fully cross-polarized thereby blocking all visible light, but allowing IR light to pass. This configuration is especially useful when photographing scenes that are illuminated by an IR light source. By blocking visible light and allowing only IR light through, the user can sharply focus the scene. This is because most lenses are corrected for visible light, but not corrected for IR light. This feature is a cost effective way to see a focused IR light image.

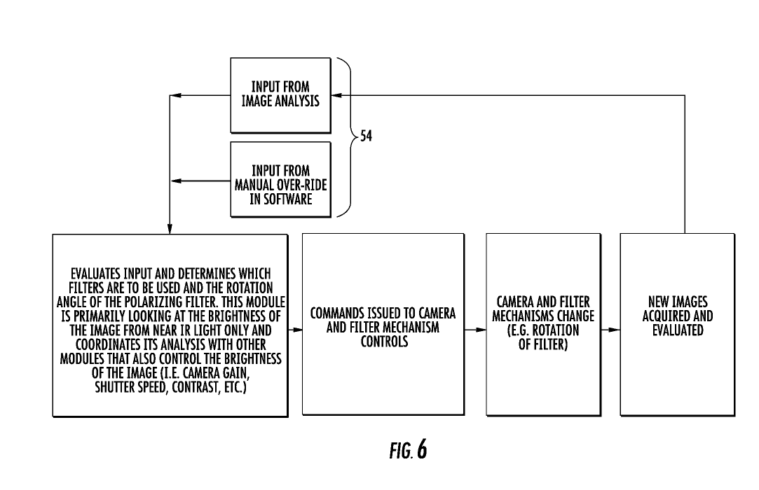

FIG. 6 shows a flowchart for a method of using the third filter configuration shown in FIG. 2. A computer can be used to continuously evaluate the quality of the image and adjust the filter 24 automatically. The loop illustrated in the FIG. 6 is iterated until the optimal image is acquired. The optimal image is the brightest image with the best contrast when looking at the near IR light that falls on the camera's 12 sensor. The loop runs constantly to make small corrections in rotational position of the polarizing filter 24 to constantly maintain the optimal image as environmental conditions change. As shown in FIG. 6, the system receives input information 50 including information related to brightness and whether the manual over-ride has been selected by the user. The manual over-ride function stops the automated computer process and allows the user to input his/her own settings. The system evaluates the input information 50 and determines which filters are to be used. As discussed above, the stationary polarization filter 22 and rotatable polarization filter 24 are used in this configuration without the IR filter 26. After the filters 22, 24 are moved in front of the aperture they are adjusted until they are at 90 degrees to each other so that little or no visible light passes through to the aperture. The system then uses the input information 50 to determine the brightness of the image from near IR light. The system coordinates with other modules of the camera 12 that related to brightness of the image such as camera gain, shutter speed, and contrast. The system rotates the filter 24 to its appropriate position to acquire a new IR image. The process is then repeated using the new image input information 50.

In addition to the filter assembly configurations discussed above, the present invention comprises an image enhancement system that can be used separately or with any of the filter assembly embodiments described herein. The image enhancement system aids in creating a clear photographic image by using a computer (or any other suitable electronic data manipulating machine) to accomplish several different tasks. It translates shades of gray or color that are not visible to the human eye into a range that is visible to the human eye. It removes blur due to spherical aberration, producing a more accurate sharper image. It enhances edges in a precise way. It uses information in the invisible infrared and ultraviolet spectra to reveal features that are otherwise invisible or barely visible to the human eye. It reveals patterns composed of very subtle shades of difference (as little as one or two intensity levels) and increases the contrast on these items. These tasks are accomplished through processes relating to deconvolution, multi-spectral imaging, edge enhancement, and dynamic range translation.

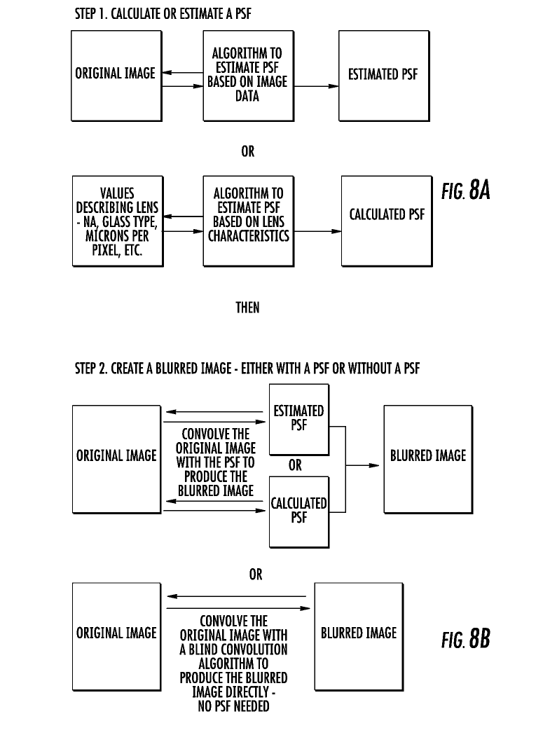

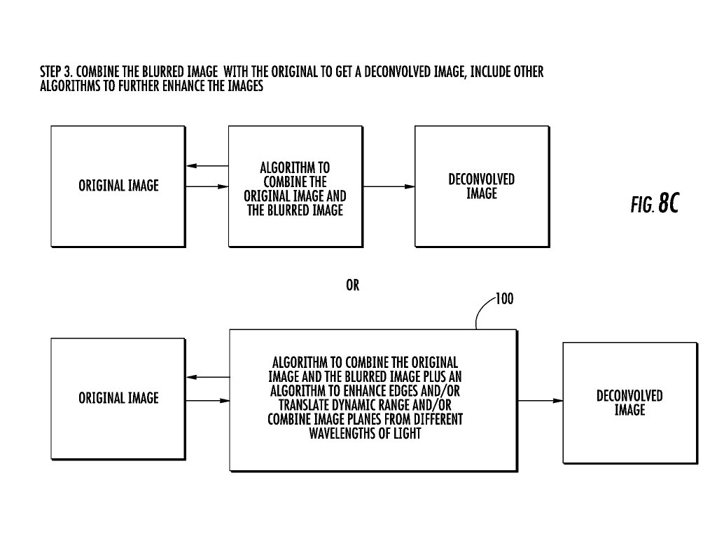

The deconvolution step helps to sharpen the captured image. Deconvolution generally includes three steps as shown in FIGS. 8a, 8b, and 8c. The first step involves calculating or estimating a point spread function (PSF) for the lens being used. The second and third steps involve removing blur from an image with the point spread function to obtain a deconvolved image.

The point spread function is information about the blurring function for the lens. As shown in FIG. 8a, there are several different methods for calculating a point spread function. These methods may include calculating or estimating the point spread function. Any or all of these functions may be employed in this image enhancement system. If the point spread function is calculated, then the system must have information about the lens. That information includes the lens numerical aperture (F number), the microns per pixel for the camera chip, the zoom factor, the medium through which the light is traveling (usually air), and the wavelength of light (usually mixed white light). This information is taken from a table that holds the values for each lens and camera that the system uses. This information is entered into a formula which calculates the point spread function for the system. The information in that point spread function is then reduced to a kernel, or symmetrical array of numbers, that is passed over the image. The kernel can vary in size, however, the preferable range is between 3×3 to 256×256.

It is also possible to estimate a blurring function for a lens without precisely knowing the values associated with that lens. There are two ways to estimate a point spread function. The first can be done by analyzing an image that is acquired using a given lens. This is often done by pointing the lens at a standard optical target, then measuring the amount of blur in the image as a result of the light passing through the lens. It is also possible to estimate the point spread or blurring function with images that are not looking at optical targets, although this may be less accurate. This process of estimating the point spread function is done by identifying what should be a straight line with sharp contrast and measuring the difference between the sharp contrast that should be there and the blurred contrast that is already there.

A second method for estimating a point spread function does not use a target, rather, it uses the intrinsic blurring information contained in the image. This is done by simply blurring an image with what is believed to be a good guess of the point spread function, then subtracting the blurred image from the original, then measuring the difference, then calculating a measurement of the sharpness of the new image using a variance or some other measure, then iterating on this process until a solution is reached. A solution is reached when the blurring process can no longer extract additional blur from the image. The result is a sharpened image and an estimate of the point spread function which can be applied to other images. This is usually only done once with one image to get the point spread function. However, this method could also be used to sharpen every image if the computer being employed is fast enough.

After the point spread function is calculated or estimated, the next step in deconvolving the image is to de-blur the image. This step is illustrated in FIG. 8b. This second step involves passing the point spread function kernel over the image. The kernel is placed with the center of the kernel over every pixel in the image. A mathematical formula is used to blur the image based on the information in the kernel and a new image is created with the same number of pixels as the original image. The second image is the blurred image. When this process is complete, the first image is subtracted from the blurred image to create a sharpened image. This process may be repeated and iterated, or not, to improve the process.

For most applications, the image enhancement system estimates the blurring function and performs several iterations on the image to remove the blurring. During each iteration, each pixel is weighted based on its location in the dynamic range. Very bright and very dark pixels are weighted to bring their values closer to the middle gray range. This is done to reduce the dynamic range to one that easier for the human eye to perceive. For color images, the color planes are separated and the process is performed on one or all of the planes, and they are then reassembled into a color image when the process is complete.

The weighting of the pixel values in the image during each deconvolution iteration serves two purposes. First it reduces the dynamic range of each pixel to one that the human eye perceives more easily, but more importantly, it uses the information that the camera gathered in the invisible spectra, i.e., the infrared and ultra violet portions, and reduces it to values that can be seen in the image. This is called multi-spectral imaging and it is shown in box 100 in FIG. 8c as an additional step after deconvolution.

Multi-spectral imaging allows the camera to capture light from individual frequencies and analyze them separately, then combine the information from the separate spectral images to derive more information than if the mixed spectral image had been analyzed by itself. In one embodiment, the camera chip in this system can acquire light from about 400 nm to 900 nm or more. Using the various filters it can extract individual spectral images from that range and analyze and enhance them separately. Typically, the system will look at the red, green, blue and infra red wavelengths separately and combine them after enhancement. The deconvolution, edge enhancement, dynamic range translation and other enhancement techniques will produce different results on the different spectral images. This is particularly true of the edge enhancement procedure. For example, edges and pigment spots may appear in the edge enhanced image from the red or infra red image that are not apparent in the other images. When the edge enhanced and deconvolved images from those spectra are recombined with the other spectra to form a normal color image, the spots will appear. The spots most likely would not be present if the image were analyzed as a single spectrum image.

In some embodiments, variance information is calculated for the edges of the image during each iteration. That variance information is a by product of the mathematics done for calculating the point spread function. That variance information reveals edges in the image. That information is then used to weight pixels in the image to emphasize the edges.

During the application of the de-blurring kernels in each iteration, there are controls for determining how much blur is removed from each iteration. Usually, the controls are set to do several iterations and remove a small amount of blur for each iteration. This allows for adjusting the “sharpness” of the image that is the final product.

The image enhancement system preferably uses a camera chip with more bit depth than eight bits, preferably it uses a twelve or sixteen bit camera chip. These greater bit depth camera chips increase the dynamic range of the camera chip. These greater bit depth chips also often are more sensitive to the infrared and ultra violet spectra. The extra dynamic range is needed because it carries additional information that is not captured in eight-bit images. The increased sensitivity to other wavelengths is important because there is information in the photons coming from the infrared region that is not there in photons coming from the visible region.

### Exemplary Purposes and Operational Modes

The above described invention can be used for many different practical applications. Below is a description of twelve applications for which the above described invention may be used. It should be noted that the applications described below are merely exemplary and that the invention may be used for additional applications not specifically described herein.
1) The invention may be used to remove glare from windows and windshields and enhance the images of the objects or persons on the other side of the window or windshield. The invention accomplishes this through several steps. The user may use either the first or second filter configuration described above. One of the polarizing filters 24 can be rotated with a motor 14. This will reduce the glare and capture an image having the least amount of glare.

The image is improved even more by employing the image enhancement system. The image enhancement is needed because the ability to see what is on the other side of a windshield or piece of glass often requires more than just removing the glare. The glare reflecting from the windshield overwhelms the light passing through the glass. Removing the glare allows the camera to acquire the light coming from behind the glass. However, the light coming from behind the glass is often obscured by shadows, blurring and other aberrations. The additional steps of deconvolution, edge enhancement, dynamic range translation and multi-spectral imaging extract additional information from the transmissive portion of the light coming from behind the glass. The empirically derived point spread function that is used with the deconvolution incorporates the consequences of the light passing through the infrared and polarizing filters.

The image is captured with a twelve bit or sixteen bit camera which yields many more shades of gray or color than an eight bit camera. Most of these shades are not perceptible to the human eye. These extra shades of gray or color, particularly in the infrared range, are then combined and translated into ranges that the human eye can perceive.
2) The invention may be used to make invisible sub-dermal skin pigment patterns visible in an image. Skin pigment patterns are stable over time and are caused by natural variations in pigment and pigment damage from aging and sunlight exposure. Sub dermal skin pigment patters are unique from person to person. Making these pigment patters visible is possible because of the differential absorption of different wavelengths of light by the skin and the pigment, and the fact that the infrared (700 nm to 1200 nm) and ultra violet (below 360 nm) spectrum of light is invisible to the human eye and penetrates deeper into the skin. The algorithms used with the image enhancement system or filter assembly enhance these images to make the pigment patterns visible thereby allowing an individual in an image to be positively identified and photographed from a long distance without needing to see the subject's face. This can be accomplished with natural sunlight and most artificial lights. No special lighting or environmental conditions are needed for this technique to work.
3) The invention may be used to make sub-dermal patterns in vasculature visible to the human eye. Under normal conditions, these vasculature patterns are invisible or barely visible to the human eye. The image enhancement system makes these patters visible because the camera 12 can operate in a mode that allows only near infrared (700 nm to 1200 nm) and ultra violet (below 360 nm) light to pass through the filters to the camera chip (third filter assembly configuration). This light can penetrate several millimeters under the skin and illuminate the vasculature. The algorithms used with the image enhancement system then enhance these images to make the vasculature patterns visible thereby allowing an individual to be positively identified and photographed from a long distance and without needing to see the subject's face.
4) The invention may be used to image and clarify dermal ridges (fingerprints and dermal ridge prints on feet) taken at a distance of several inches to several feet. All other fingerprint systems require direct contact with a body part to image dermal ridges. The image enhancement system or filter assembly can acquire images of hands and feet at distances of several feet and resolve fingerprints as a result of the magnification of the lens, the quality of the lens, the filter assembly, the bit depth of the camera (twelve bits or sixteen bits, as opposed to eight bits), and the algorithms that are applied to the images after they are acquired to enhance the details and expose the dermal ridges.
5) The invention may be used to identify invisible or barely visible patterns in objects being observed. For example, license plates and other items often have watermarks embedded in them. These watermarks are invisible or barely visible to the human eye under normal illumination. The image enhancement system and filter assembly can often resolve these marks and make them visible. Other examples include making tire treads visible, making dirt patterns on cars and trucks visible, making damage to objects visible (such as dents in cars or trucks). All of this can be done with normal illumination.
6) The invention may be used to identify invisible patterns in objects using the infrared spectrum. By using a combination of the filters in the camera 12, it is possible to set the camera 12 into a mode in which only near infrared light (700 nm to 1200 nm) passes to the chip on the camera 12 (third filter assembly configuration). These wavelengths are invisible to the human eye but visible to the camera. Operating in this mode, it is possible to see patterns in objects that are otherwise invisible. This mode of operation does not require the use of the algorithms on the camera 12 to clarify the image. However, those algorithms will enhance the images acquired in this mode. The filter assembly accomplishes this by using two cross-polarizing filters that are placed at 90 degree orientation to each other to block all visible light and allow infrared light pass. Another unique mechanism of the filter assembly in this regard is the ability of the user to adjust the orientation of the cross-polarizing filters to allow for a mixture of infrared and visible light. This mixture can be infinitely varied from all visible light to all infrared light. Examples of some of the patterns that can be seen in this mode are changes in colors of objects (dark objects in the visible spectrum may be light in the infrared spectrum), patterns that emerge in the infrared spectrum in stitching in clothes, or letters on emblems sewn into clothes, residue on objects that will illuminate in the infrared spectrum and not the visible spectrum.
7) The invention may be used to substitute for an iris or automated iris in a camera lens system. Most camera systems use an iris to control the amount of light that reaches the camera chip. There is usually feedback to the iris from the system to maintain a constant light level on the chip. The iris works by opening and closing, making a hole in the center of the iris larger or smaller. Opening and closing the iris changes the light levels, but there are side effects that are sometimes unwanted, or there are applications where an automated iris are not possible. Opening and closing an iris changes the depth of field in an image and can cause blurring. There are applications where there is no feedback for an automated iris (some cameras don't have a feedback mechanism), or there are optical devices that don't have automated irises built in—such as reflective lenses. The filter assembly uses two cross-polarizing filters 22, 24 to create a neutral density filter that can be adjusted to limit the amount of light that falls on a camera chip. This obviates the need for an iris. The degree of cross-polarization, and hence the amount of light that falls on the camera chip, can be controlled manually by the operator, or through an computer assisted algorithm that automatically adjusts the light level falling on the camera chip to maintain a constant light level. This process does not require the systems for removing glare, sharpening images, seeing fingerprints, or identifying sub dermal patterns. They are independent and mutually exclusive. However, as with all exemplary applications, the filter assembly can be used with the image enhancement system if desired.
8) The invention may be used to remove “blooming” artifacts in camera chips. Many camera chips will produce bright horizontal or vertical lines if an extremely bright light source falls on them. These lines produce an effect known as “blooming”. The bright lines will traverse the entire length or breadth of the image and can obscure important details in the image. The image enhancement system or filter assembly can be used to remove these bright line artifacts due to blooming. This is accomplished by inserting both cross-polarizing filters at once and rotating one of the filters until the blooming artifact disappears (second filter assembly configuration described above). This can be done manually by a user, or automatically and controlled by an algorithm running on a computer.
9) The invention may be used to remove diffracted light from a window in front of the camera due to dirt and debris on the window. A major problem for surveillance cameras occurs when light from the sun or some other sources shines directly or nearly directly into the camera lens through a window that has dirt or debris on it. The bright light is diffracted by the dirt and makes it difficult to see through. The filter assembly can be used to attenuate this diffracted light and give a clearer image. This is done by inserting both cross-polarizing filters and rotating one of those filters to minimize the diffraction (second filter assembly configuration described above). The effect is produced by eliminating the polarized glare and by attenuating the bright light.
10) The invention may be used to distinguish between living and dead or artificial plants. All living plants that use chlorophyll reflect green light, absorb red light and emit light in the near infrared spectrum (700 nm to 1200 nm). When viewed with a camera using the third filter assembly embodiment described above, living plants will glow white. Dead or artificial plants will not glow. The filter assembly accomplishes this by inserting two cross polarizing filters, adjusting the filters to block all visible light, and removing the infrared filter. This permits only infrared light to pass through to the camera chip. There are many applications for this feature. It could be used to help identify snipers who have pulled plants and added them to their camouflage. It may be useful in identifying and interdicting drugs. It may have commercial applications to identify healthy vs. sick lawns, trees or flowers.
11) The invention may be used to identify sources of infrared illumination. In the third filter assembly embodiment described above, the filter assembly only allows infrared light (700 nm to 1200 nm) to pass through to the camera chip. In this mode, it sees only infrared light and can identify sources of infrared illumination in the 700 to 1200 nm range. The image enhancement system or filer assembly accomplishes this by inserting cross polarizing filters 22, 24, adjusting the filters 22, 24 to block all visible light, and removing the infrared filter 26. There are several possible applications for this. One would be to use the image enhancement system or filter assembly in counter-intelligence. Operatives sometimes scan buildings with infra-red lasers to identify cameras in windows. The filter assembly could identify those sources of illumination.
12) The invention may be used to generally sharpen and remove blur due to spherical aberration in images acquired with the image enhancement system or filter assembly. Some blur in digital images is a consequence of spherical aberration. This is a natural consequence of light passing through curved glass. It is possible to very precisely remove that blur and produce an image that more accurate and more representative of the original blurred image. This is known as deconvolution. The images produced by this process are more accurate than those on which a general purpose sharpening algorithm is used—which may sharpen an image but may not be accurate. The image enhancement system uses deconvolution to produce accurate, de-blurred images.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. A filter assembly adapted to selectively prevent certain light waves from passing through an optical device, said filter assembly comprising:
a polarizing filter movable between a first position wherein the polarizing filter does not prevent visible light from passing through the optical device,
and a second position wherein the polarizing filter prevents certain orientations of visible light from passing through the optical device, wherein the polarizing filter is adapted to rotate to change the orientation of visible light that is prevented from passing through the optical device when the polarizing filter is in its second position.

2. The filter assembly of claim 1 wherein the optical device is a camera.

3. The filter assembly of claim 1 wherein the polarizing filter is moved between its first position and its second position by a motor.

4. The filter assembly of claim 1 wherein the polarizing filter is rotated by a motor.

5. A method for removing glare from an image using a filter assembly having a polarizing filter to prevent certain visible light waves from passing through an optical device wherein the polarizing filter is rotatable and movable between a first position wherein the filter does not prevent visible light waves from passing through the optical device and a second position wherein the polarizing filter prevents certain orientations of visible light from passing through the optical device, said method comprising the steps of:
(a) receiving input information about the image;
(b) moving the filter to its second position to prevent certain orientations of visible light from passing through the optical device;
(c) determining the amount of glare contained in the image;
(d) rotating the polarizing filter to acquire a new image having a different amount of glare;
(e) repeating steps (c) and (d) using the new image's glare information until the image seen by the optical device contains the desired amount of glare.

6. The method of claim 5 wherein the amount of glare in the image is determined by looking at the variance in the image.

7. The method of claim 5 wherein the input information comprises one or more of the time, the angle of polarized light, the brightness of the image, the amount of glare that is in the image, whether the image is moving, and whether the manual over-ride has been selected.

8. The method of claim 5 wherein the filter assembly further comprises an infrared filter movable between a first position wherein the infrared filter does not prevent infrared light waves from passing through the optical device and a second position wherein the infrared filter prevents infrared light waves from passing through the optical device.

9. The method of claim 8 further comprising the step of moving the infrared filter to its section position.

10. The method of claim 5 wherein the amount that the polarizing filter is rotated is determined based on the image glare information that is relayed to a computer.

11. A filter assembly adapted to selectively prevent certain light waves from passing through an optical device, said filter assembly comprising:
a first polarizing filter movable between a first position wherein the first polarizing filter does not prevent visible light from passing through the optical device, and a second position wherein the first polarizing filter prevents certain orientations of visible light from passing through the optical device;
a second polarizing filter movable between a first position wherein the second polarizing filter does not prevent visible light from passing through the optical device, and a second position wherein the second polarizing filter prevents certain orientations of visible light from passing through the optical device, wherein the second polarizing filter is adapted to rotate to change the orientation of visible light that is prevented from passing through the optical device when the second polarizing filter is in its second position; and
an infrared filter movable between a first position wherein the infrared filter does not prevent infrared light waves from passing through the optical device and a second position wherein the infrared filter prevents infrared light waves from passing through the optical device.

12. The filter assembly of claim 11 wherein the optical device is a camera.

13. The filter assembly of claim 11 wherein the first polarizing filter, second polarizing filter, and infrared filter are moved between their first position and their second position by at least one motor.

14. The filter assembly of claim 11 wherein the second polarizing filter is rotated by a motor.

15. A method for controlling the brightness of an image using a filter assembly having a first and second polarizing filter each adapted to prevent certain light waves from passing through an optical device, wherein the second polarizing filter is rotatable and both filters are adapted to independently move between a first position wherein the filters do not prevent certain light waves from passing through the optical device and a second position wherein the filters prevents certain light waves from passing through the optical device, said method comprising the steps of:
(a) receiving input information about the image;
(b) moving both polarizing filters to their second position in front of the optical device to create an adjustable neutral density filter;
(c) determining the amount of brightness in the image;
(d) rotating the second filter until the brightness is attenuated thereby creating a new image;
(e) repeating steps (c) and (d) using the new image's brightness information until the image seen by the optical device has the desired amount of brightness.

16. The method of claim 15 wherein the filter assembly further comprises an infrared filter movable between a first position wherein the infrared filter does not prevent infrared light waves from passing through the optical device and a second position wherein the infrared filter prevents infrared light waves from passing through the optical device.

17. The method of claim 16 further comprising the step of moving the infrared filter to its second position.

18. The method of claim 15 wherein the amount that the second filter is rotated is determined based on image brightness information that is relayed to a computer.

19. The method of claim 15 wherein the distance that the second filter is rotated is determined from look-up tables of pre-known values.

20. A method for viewing infrared images using a filter assembly having a first and second polarizing filter each adapted to prevent certain light waves from passing through an optical device, wherein the second polarizing filter is rotatable and both filters are adapted to independently move between a first position wherein the filters do not prevent certain light waves from passing through the optical device and a second position wherein the filters prevents certain light waves from passing through the optical device, said method comprising the steps of:
(a) receiving input information about the image;
(b) moving both polarizing filters to their second positions; and
(c) rotating the second filter until it is orientated ninety degrees relative to the first filter which creates a neutral density filter that prevents visible light from passing through the optical device yet still allows infrared light to pass through the optical device.

21. A method for enhancing an image as seen through an optical device having at least one filter adapted to prevent certain light waves from passing through the optical device, said method comprising the steps of:
(a) receiving input information about the image;
(b) moving the filter in front of the optical device;
(c) deconvolving the image;
(d) performing multi-spectral imaging on the image;
(e) performing edge enhancement on the image;
(f) performing dynamic range translation on the image.

22. The image enhancement system of claim 21 wherein deconvolving the image further comprises the step of calculating a point spread function.

23. The image enhancement system of claim 21 wherein deconvolving the image further comprises the step of estimating a point spread function.

24. The image enhancement system of claim 21 wherein deconvolving the image further comprises the step of de-blurring the image.

25. The image enhancement system of claim 21 wherein the optical device is a camera.

26. The image enhancement system of claim 25 wherein the camera further comprises a twelve bit chip.

27. The image enhancement system of claim 25 wherein the camera further comprises a sixteen bit chip.
